(19) United States
(12) Patent Application Publication
(10) Pub. No.: US 2021/0375069 A1
(43) Pub. Date: Dec. 2, 2021

(54) SYSTEM AND METHOD FOR AUTOMATIC MANAGEMENT OF UNMANNED PARKING LOT

(71) Applicant: Nam A KIM, Incheon (KR)

(72) Inventor: Nam A KIM, Incheon (KR)

(21) Appl. No.: 17/287,904

(22) PCT Filed: Dec. 3, 2019
(86) PCT No.: PCT/KR2019/016949

§ 371 Date: Apr. 22, 2021

(30) Foreign Application Priority Data
Dec. 4, 2018 (KR) 10-2018-0154555

(51) Int. Cl. G07B 15/02; G06Q 30/02; G06Q 20/34; G06Q 20/40

(52) U.S. Cl. CPC G07B 15/02; G06Q 30/0284; G06Q 30/0207; G06Q 20/4014; G06Q 20/352

(57) ABSTRACT

Disclosed in the present invention is a system for automatic management of an unmanned parking lot. More specifically, the present invention relates to a system for automatic management of an unmanned parking lot, in which the system recognizes whether a vehicle enters a parking lot and is parked, and automatically processes a payment depending on parking time. Depending on an embodiment of the present invention, a card terminal mounted in a vehicle in each parking space of the unmanned parking lot is recognized, and procedures of vehicle identification, parking approval, payment, etc. are automatically performed in connection with a card system, such that it is possible to provide convenience of parking to an owner of a vehicle and the operator of the parking lot.

### TECHNICAL FIELD

The present invention relates to a system for automatic management of an unmanned parking lot, and more particularly, to a system for automatic management of an unmanned parking lot, in which the system recognizes whether a vehicle enters a parking lot and is parked, and automatically processes a payment settlement depending on parking time.

### BACKGROUND ART

Currently, the penetration rate of vehicles has increased to more than one vehicle per one household, and as a result, the shortage of supply compared to the demand for parking spaces has intensified, causing friction between neighbors due to parking problems, or when an emergency occurs such as a fire engine or ambulance in the resident area needs to enter, problems such as inability to relevantly deal with unauthorized parking on a back road have occurred continuously.

In order to solve the above problems, the resident-priority parking system has been enforced. This system allows residents to park their vehicles conveniently at low usage fees by setting up designated parking zones on back roads of residential areas in order to relieve serious parking problems in the city central areas.

However, despite the introduction and enforcement of the resident-priority parking system, when the parked vehicle moves out, an unauthorized vehicle is parked in the designated parking area while ignoring the designated parking area, so there is a situation that the authorized vehicle does not park in the designated parking area. In addition, since the unauthorized vehicle cannot use the designated parking area even if the designated parking area is empty, the efficiency is lowered.

In general, public parking lots managed by the city have a system built on an individual local basis, and people can freely use the public parking lots at a relatively low cost. However, in order to obtain a benefit in terms of cost, it is necessary to purchase a commuter pass and in the case of a parking lot that does not enforce a dual parking policy, there is a disadvantage in that other vehicles cannot use the parking area during the time in which the parking area is empty, similar to the above-described resident priority parking system.

### DISCLOSURE

### Technical Problem

The present invention has been made to solve the above-described problems, and an object of the present invention is to provide a system and a method for automatic management of an unmanned parking lot, capable of automatically performing a series of procedures such as vehicle confirmation, parking approval, and payment settlement by detecting vehicles approaching each parking surface within the parking lot.

### Technical Solution

In order to achieve the object described above, depending on an aspect of the present invention, there is provided a system for automatically managing an unmanned parking lot, the system including: a plurality of parking lot terminals installed in parking lots in each region and configured to communicate with a card terminal mounted in a vehicle approaching within a predetermined distance to recognize an electronic IC card and calculate a parking time; and a management server configured to request authentication of the electronic IC card from a linked external card system, approve parking for an authenticated vehicle, and process a payment settlement procedure depending on the calculated parking time of the vehicle, in response to a request for parking approval and payment settlement from the plurality of parking lot terminals.

The parking lot terminal may include a card recognition unit configured to recognize an adjacent electronic IC card through a wireless communication network; a communication unit connected to the management server to perform data communication; a time calculation unit configured to calculate the parking time of the vehicle; a parking processing unit configured to perform a process of parking a currently recognized vehicle depending on parking approval by the management server; and a control unit configured to request the parking approval and payment settlement to the management server and provide the calculated parking time to the management server when the parking is terminated.

The time calculation unit may be configured to set a time point at which recognition of the electronic IC card is terminated as a parking start time, and set a time point at which the electronic IC card is re-recognized as a parking termination time, after the parking is processed.

The management server may include a terminal linking unit and a card linking unit connected to the plurality of parking lot terminals and a card system to perform data communication, respectively; a parking management unit configured to request authentication of the electronic IC card to the card system depending on the parking approval request from the parking lot terminal, and return the parking approval to the parking lot terminal depending on an authentication result; and a parking information collection unit configured to generate parking information for parking-approved cases, collect the generated parking information, and store the generated parking information in a parking information DB.

The management server may further include a fee calculation unit configured to calculate a fee corresponding to the parking time and request payment settlement through the electronic IC card to a high-pass system.

The management server may further include a rate setting unit configured to adjust the fee by applying a discount rate set differently for each time slot with reference to the parking information

The electronic IC card may include a high-pass card, a credit card, or a transportation card having a post-payment function.

In addition, in order to achieve the object described above, depending on another aspect of the present invention, there is provided a method of automatically managing an unmanned parking lot by a management server, which includes: receiving, by the management server, a request for parking approval depending on recognition of an electronic IC card provided in a vehicle from a plurality of parking lot terminals installed in parking lots in each region; receiving card information of the electronic IC card to determine whether the electronic IC represents a member, and requesting authentication of a vehicle from a linked card system in a case of a registered member; performing a process of parking an authenticated vehicle and returning a parking approval to the parking lot terminal when the vehicle is authenticated by the card system; and processing a payment settlement procedure depending on a calculated parking time of the vehicle when move-out of a vehicle is reported from the parking lot terminal as parking of the vehicle is terminated.

The method may further include: setting, by the parking lot terminal, a time point at which recognition of the electronic IC card is terminated as a start time point of the parking time between the returning of the parking approval and the terminating of the parking of the vehicle; and setting, by the parking lot terminal, a time point at which the electronic IC card is re-recognized as a parking termination time.

The processing of the payment settlement procedure may include: receiving the parking time of the vehicle from the parking lot terminal and storing the parking time as parking information; calculating a fee corresponding to the parking time; and requesting payment settlement through the electronic IC card to the card system.

The calculating of the fee corresponding to the parking time may further include: adjusting the fee by applying a discount rate, which is set differently for each parking time slot.

### Advantageous Effects

Depending on an embodiment of the present invention, a card terminal mounted in a vehicle in each parking space of the unmanned parking lot is recognized, and procedures of vehicle identification; parking approval, payment settlement, etc. are automatically performed in connection with a card system, so that it possible to provide convenience to an owner of a vehicle and an operator of the parking lot in relation to the parking.

### DESCRIPTION OF DRAWINGS

FIGS. 1a and 1b are diagrams schematically illustrating an overall configuration of a system for automatic management of an unmanned parking lot depending on an embodiment of the present invention.

FIG. 2 is a diagram showing the structure of a parking lot terminal of an automatic management system for an unmanned parking lot depending on an embodiment of the present invention.

FIG. 3 is a diagram showing the structure of a management server of an automatic management system for an unmanned parking lot depending on an embodiment of the present invention.

FIG. 4 is a flowchart showing a method for automatic management of an unmanned parking lot depending on an embodiment of the present invention.

FIG. 5 is a sequence diagram illustrating a method for automatic management of an unmanned parking lot depending on an embodiment of the present invention.

### BEST MODE

### Mode for Invention

Prior to the description, throughout the specification, when some part is referred to as to “comprise” or ‘include’ some elements, unless explicitly described to the contrary, it means that other elements may be further included but not excluded.

In the present specification, the term “embodiment” is intended to serve as an illustration or example, but the subject matter of the invention is not limited by such an example. In addition, although “comprising”, “including”, “having” and other similar terms are used herein, when used in the claims, they are collectively used to have the meaning of “comprising” which is an open transition word that does not exclude any additional or other elements.

Further, the terms ‘-unit’, ‘-device’, and ‘-system’ described throughout the specification mean the unit for processing an operation having at least one or two functions and it can be implemented by hardware or software and a combination thereof.

The various techniques described herein may be implemented with hardware or software, or, where appropriate, with a combination thereof. As used herein, terms such as “unit”, “device” and “system” are similarly treated as computer-related entities, that is, hardware, a combination of hardware and software, software, or equivalent to software at the time of execution. In addition, in the present invention, the system may be configured in a “unit”, and may be recorded in one physical memory in a readable, writable, and erasable form, or may be distributed in two or more memories or recording media.

Hereinafter, a system and a method for automatic management of an unmanned parking lot depending on an embodiment of the present invention will be described with reference to the drawings.

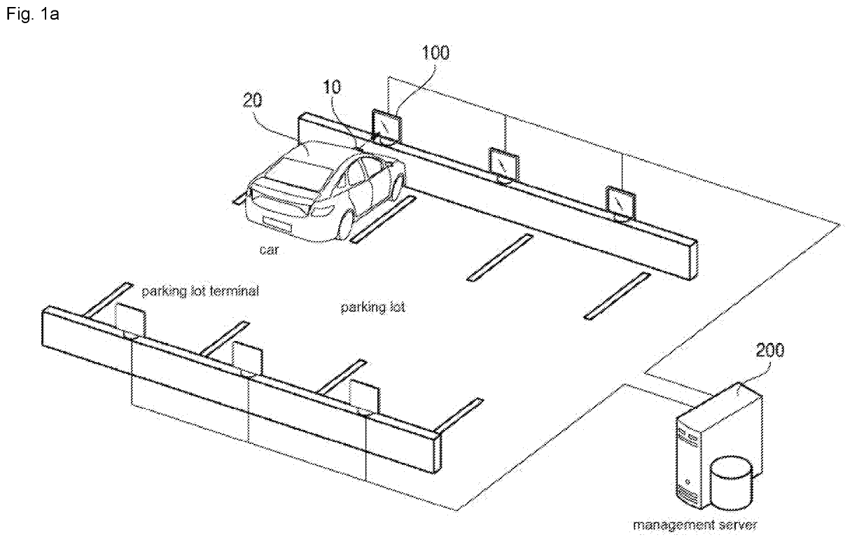

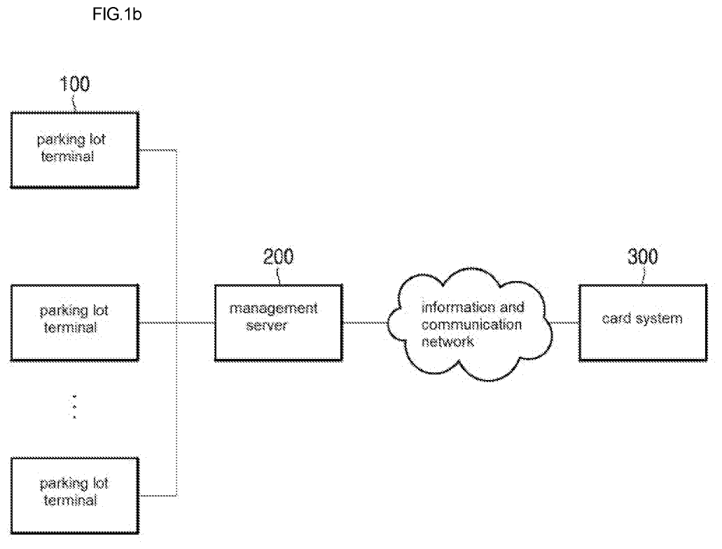

FIGS. 1a and 1b are diagrams schematically illustrating an overall configuration of a system for automatic management of an unmanned parking lot depending on an embodiment of the present invention.

Referring to FIGS. 1a and 1b, a system for automatically managing an unmanned parking lot depending on an embodiment of the present invention may include a plurality of parking lot terminals 10 installed in parking lots in each region and configured to communicate with a card terminal mounted in a vehicle approaching within a predetermined distance to recognize an electronic IC card and calculate a parking time; and a management server configured to request authentication of the electronic IC card from a linked external card system, approve parking for an authenticated vehicle, and process a payment settlement procedure depending on the calculated parking time of the vehicle, in response to a request for parking approval and payment settlement from the plurality of parking lot terminals.

The parking lot terminal 100 is for an unmanned parking lot, but is not limited thereto. The parking lot terminal 100 may be installed in a parking lot in which a plurality of parking surfaces are defined, and may be installed on one side of each parking surface to recognize a vehicle approaching, and interwork with the management server 200 to provide a series of procedures required for parking.

Alternatively, although not shown, the parking lot terminal 100 may be installed at the entrance and exit of the parking lot, one at the entrance and one at the exit of the parking lot, in order to calculate the time by identifying the electronic IC cade installed in the vehicles entering the parking lot, and then perform the payment settlement depending on the time when the vehicles move out from the parking lot.

In order implement this function, the parking lot terminal 100 may be provided with a sensor and a communication device to recognize the approach of the vehicle 20 through the sensor, and to communicate with the card terminal 10 installed in the vehicle 20 to receive card information of the electronic IC card. In addition, the parking lot terminal 100 may request the approve for parking by transmitting the card information received in association with the management server 200 installed in the corresponding parking lot or in the region through a wired or wireless network. When the packing is approved, the parking lot terminal 100 can calculate the parking time for the corresponding vehicle, and when the vehicle moves out depending on the termination of the parking, the parking lot terminal 100 may report the termination of the parking and request the payment settlement end to the management server 200.

The management server 200 may interwork with the plurality of parking lot terminals 100 installed in the designated parking lot to check the membership with respect to the vehicle that enters the parking surface and attempts the parking, and may interwork with a high-pass system 300 through an information and communication network to perform procedures such as high-pass authentication verification and parking approval through card information, and in particular, may request the payment settlement to the high-pass system 300 depending on the parking time.

That is, the management server 200 depending on an embodiment of the present invention may process the membership verification, parking approval, and payment settlement procedures through card information obtained from the electronic IC card recognized by the parking lot terminal 100.

In particular, depending on the embodiment of the present invention, an electronic IC card used as an authentication medium may include a high-pass card, a credit card, or a transportation card having a post-payment function, and preferably, a high-pass card generally installed in the vehicle may be used.

The management server 200 may include a server device having a high-performance microprocessor, a high-capacity memory, and a storage to perform a procedure and a response in real time depending on the request from a plurality of parking lot terminals.

In addition, the automatic management system for an unmanned parking lot depending on an embodiment of the present invention may be installed and applied not only to the unmanned parking lot, but also to a parking area in an apartment complex.

Based on the above structure, the automatic management system for the unmanned parking lot depending on an embodiment of the present invention may operate the parking lot in an unmanned manner, and may perform various procedures required for operating the unmanned parking lot by using the electronic IC card without using a separate membership recognition device and a payment device, so that the vehicle owner and parking lot operator may easily deal with the parking-related tasks. Hereinafter, the structure of the parking lot terminal of an unmanned parking lot automatic management system depending on an embodiment of the present invention will be described with reference to the drawings.

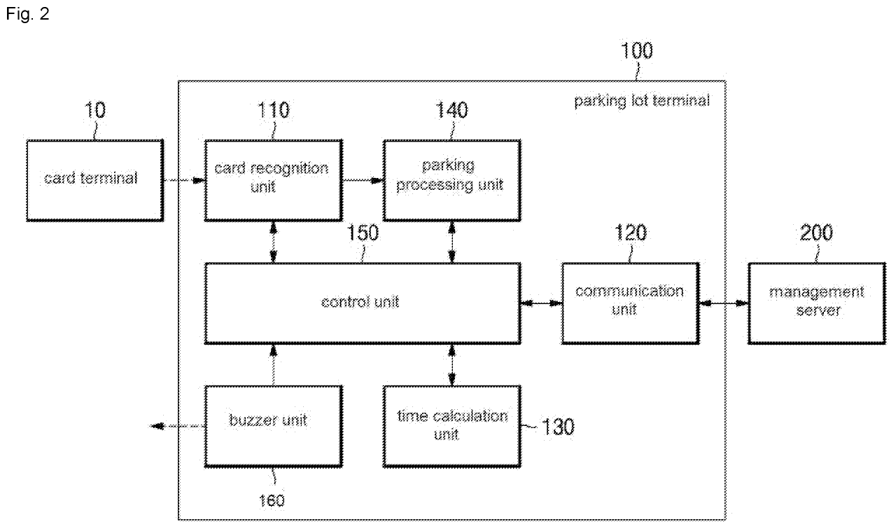

FIG. 2 is a diagram showing the structure of the parking lot terminal of an automatic management system for an unmanned parking lot depending on an embodiment of the present invention.

Referring to FIG. 2, the parking lot terminal 100 may include a card recognition unit 110 configured to recognize an adjacent electronic IC card through a wireless communication network, a communication unit 120 connected to the management server 200 to perform data communication, a time calculation unit 130 configured to calculate the parking time of the vehicle, a parking processing unit 140 configured to perform a process of parking a currently recognized vehicle depending on the parking approval by the management server 200, and a control unit 150 configured to request the parking approval and payment settlement to the management server 200 and to provide the calculated parking time to the management server 200 when the parking is terminated.

The card recognition unit 110 may recognize the card terminal 10 mounted in the vehicle entering the parking surface in the parking lot, and perform data communication with the card terminal 10 to receive card information of the electronic IC card.

In order to implement this function, the parking lot terminal 10 may be installed within an appropriate distance to recognize the card terminal 10 from the vehicle located on the parking surface, and may perform data communication with the card terminal 10 as the vehicle enters the accurate position in each parking surface.

The communication unit 120 may perform data communication with the management server 200 through wired or wireless manner. The communication unit 120 may receive information about the vehicle and the owner of the vehicle by transmitting the card information received in the card recognition unit 110 to the management server 200 under the control of the control unit 150, and may request the confirmation whether the payment processing is possible by the electronic IC card. In addition, it is possible to request the payment settlement by using the corresponding electronic IC card when the parking is terminated.

The time calculation unit 130 may calculate a parking time with respect to the vehicle for which the parking is approved. In particular, the time calculation unit 130 may receive the parking approval from the management server 200 by recognizing the electronic IC card of the vehicle under the control of the control unit 150, calculate the parking time by setting a time point at which the card terminal 10 is turned off and the electronic IC card is not recognized due to the stop of the engine of the vehicle as a parking start time, and then calculate the parking time by setting a time point at which the card terminal 10 is turned on depending on the ignition of the engine of the vehicle and the electronic IC card is re-recognized, as a parking termination time.

The parking processing unit 140 may register the parking of the vehicle and manage the parking procedure until the vehicle moves out when the parking approval is returned from the management server 200.

The control unit 150 may control each component of the parking lot terminal 100 to perform the parking procedure and the payment settlement procedure. In detail, the control unit 150 may control the communication unit 120 to request the parking approval, the parking processing depending on the response of the parking approval, and the payment settlement using an electronic IC card when the parking is terminated to the management server 200 through data communication with the management server 200.

In addition, the parking lot terminal 100 depending on an embodiment of the present invention may further include a buzzer unit 160 for notifying the disapproval of parking through a buzzer sound for a vehicle owner who is not registered as a member or a vehicle for which the card payment is not possible.

In addition, although not shown in the drawing, receivers may be further installed throughout the parking lot in order to improve the recognition rate of the parking lot terminal 100 with respect to the card terminal 10 of the vehicle that enters the parking surface. One or more of these receivers may be allocated to each parking lot terminal 100, so that the recognition rate for the electronic IC card depending on the entry and exit of the vehicle may be supplemented.

Hereinafter, the structure of the management server that is connected to the above-described parking lot terminal to perform the automatic parking lot management will be described in detail with reference to the drawings.

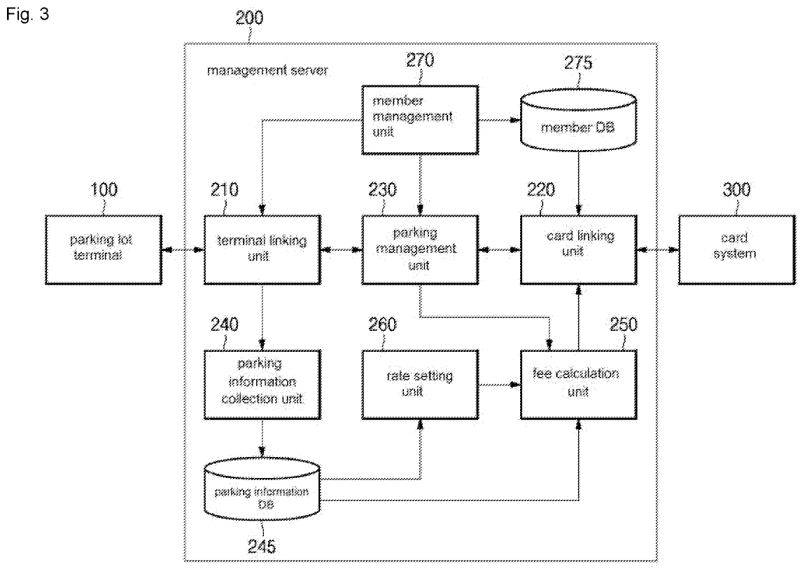

FIG. 3 is a diagram showing the structure of a management server of an automatic management system for an unmanned parking lot depending on an embodiment of the present invention.

Referring to FIG. 3, the management server 200 of an automatic management system for an unmanned parking lot depending on an embodiment of the present invention may include a terminal linking unit 210 and a card linking unit 220 connected to the plurality of parking lot terminals 100 and a card system 300 to perform data communication, respectively, a parking management unit 230 configured to request authentication of the electronic IC card to the card system 300 depending on the parking approval request from the parking lot terminal 100, and return the parking approval to the parking lot terminal 100 depending on an authentication result, a parking information collection unit 240 configured to generate parking information for parking-approved cases, collect the generated parking information, and store the generated parking information in a parking information DB 245, a fee calculation unit 250 configured to calculate a fee corresponding to the parking time and request payment settlement through the electronic IC card to a high-pass system, and a rate setting unit 260 configured to adjust the fee by applying a discount rate set differently for each time slot with reference to the parking information.

The terminal linking unit 210 may perform data communication with each parking lot terminal 100 installed in the parking lot through a wired or wirelessly manner, may receive card information recognized from the parking lot terminal 100, may request the parking authentication and may send and receive the response. In addition, the terminal linking unit 210 may transmit and receive various data required for managing the parking lot with the parking lot terminal 100.

The high-pass linking unit 220 may perform data communication with the card system 300, which is located in a remote place to operate the electronic IC card, through a wired or wireless manner, and a known information communication network may be used as the high-pass linking unit 220. The card linking unit 220 may transmit the card information acquired by the management server 200 to the card system 300, thereby authenticating the vehicle and authenticating whether the payment settlement is possible through the electronic IC card. In addition, the high-pass linking unit 220 may request the payment settlement by transmitting the parking time when the parking is terminated.

The parking management unit 230 may maintain the interworking state with each parking lot terminal 100 in real time. When the terminal linking unit 210 receives the parking request from each parking lot terminal 100, the parking management unit 230 may request authentication to the card system 300, and when the authentication is normally completed, the parking management unit 230 may transmit the parking approval to the parking lot terminal 100. In addition, the parking management unit 230 may register parking information by creating the parking information for each vehicle parked in the current parking lot from the parking start time to the parking termination time for the vehicle to which the parking is approved.

The parking information collection unit 240 may collect parking information of each vehicle registered for parking and store the parking information in the parking information DB 245. The parking information collection unit 240 is for managing the parking history from the past to the present with respect to the registered vehicles, and establishes a database by accumulating and storing the parking information of each vehicle in units of hour, day, month, and year. Such parking information may include not only date information, but also vehicle information such as a vehicle license number and information such as payment details.

The fee calculation unit 250 may perform the payment settlement procedure for a parking fee with respect to a vehicle for which the parking is terminated. The parking fee may be calculated in the unit of minutes or hours from the parking start time to the parking termination time, and the unit fee may be set differently depending on the policy of the corresponding parking lot. The fee calculation unit 250 may request the payment settlement by transmitting the parking time, which is received from the parking lot terminal 100, to the card system, and the card system 300 may settle the parking fee by referring to the card information in the same manner as known high-pass payment for vehicles, credit cards or post-paid transportation cards.

Meanwhile, the rate setting unit 260 depending on an embodiment of the present invention may apply a predetermined discount rate to the parking fee depending on the operation policy of the parking lot operator. As an example, when a large number of vacant parking spaces occur at a specific time and day, the fee may be determined by applying a high discount rate at the specific time and day.

In particular, depending on an embodiment of the present invention, the rate setting unit 260 may determine a vehicle joined for a long time of several years or more by referring to the accumulated parking information. For such vehicles joined for a long time, a progressive addition rate, not a discount, is applied to the parking fee compared to other vehicles, thereby realizing an eco-friendly policy that induces to gradually reduce the use of the vehicle in long-term basis.

That is, when it is determined that the same vehicle is steadily using the parking area for a certain period of time or longer, the system depending on the embodiment of the present invention gradually increases the fee depending on the period of use to aggravate the burden of the parking fee, thereby gradually reducing the use of the vehicle. Such a progressive rate policy may be operated in association with other parking lot systems in the nearby area such that the vehicle owner cannot avoid the policy by moving to another parking lot. Preferably, the progressive rate policy can be applied after allowing the vehicle owner to sufficiently recognize the policy by sending notification texts or e-mails to the vehicle owner in advance.

The rate setting unit 260 may apply a discount rate or an addition rate to the parking fee of a parking case for which current payment is requested depending on a preset condition, and provide the parking fee to the fee calculation unit 250, so that the fee calculation unit 250 may calculate the actual parking fee for a corresponding parking case and provide the actual parking fee to the card system 300 to adjust the parking fee during the payment settlement.

In addition, the automatic management system for unmanned parking lots of the present invention may provide a service with respect to the vehicle owners registered as members and their vehicles. The vehicle owners who want to use the service of the present invention need to register as a member through a parking lot operator or a web page in advance, and the management server 200 may determine whether the recognized vehicle owner has registered as a member based on card information of the electronic IC card.

Mien receiving the card information, a member management unit 270 may perform such a member registration procedure and determine whether to register as a member, and a member DB 275 may store member information of the registered member.

Hereinafter, a method of automatically managing an unmanned parking lot by a system depending on an embodiment of the present invention will be described with reference to the drawings.

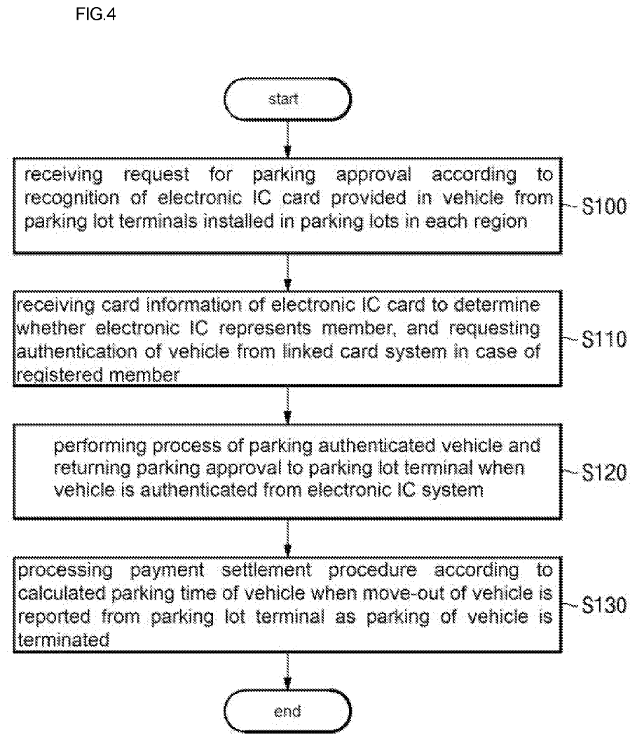

FIG. 4 is a flowchart showing a method for automatic management of an unmanned parking lot depending on an embodiment of the present invention. In the following description, the execution subject in each step is the management server and components thereof of the above-described automatic management system of unmanned parking lots, even if there is no separate indication.

Referring to FIG. 4, a method of automatically managing an unmanned parking lot by a management server depending on an embodiment of the present invention may include the steps of receiving, by the management server, a request for parking approval depending on recognition of an electronic IC card provided in a vehicle from a plurality of parking lot terminals installed in parking lots in each region (S100), receiving card information of the electronic IC card to determine whether the electronic IC represents a member, and requesting authentication of a vehicle from a linked card system in a case of a registered member (S110), performing a process of parking an authenticated vehicle and returning a parking approval to the parking lot terminal when the vehicle is authenticated by the card system (S120), and processing a payment settlement procedure depending on a calculated parking time of the vehicle when move-out of a vehicle is reported from the parking lot terminal as parking of the vehicle is terminated (S130).

Specifically, in step (3100) of receiving the request for parking approval, the vehicle is recognized by the parking lot terminal installed in each local public parking lot or a parking lot in an apartment complex to which the system of the present invention is applied, so that the management server receives card information there from.

Accordingly, in step (S110) of requesting the vehicle authentication, the management server determines the member registration based on the card information, and in the case of a registered member, the card information is provided to the high-pass system to request authentication of the corresponding high-pass card. In the case of an unregistered vehicle owner, the member registration may be requested through the parking lot terminal.

Next, in step (S120) of returning the parking approval to the parking lot terminal, if the authentication result is normally returned from the card system, the management server generates parking information to register the parking of the corresponding vehicle, and returns the parking approval result to the corresponding parking lot terminal.

Subsequently, in step (S130) of processing the payment settlement procedure depending on the calculated parking time of the vehicle, after a predetermined time elapses, the parking completion for the registered vehicle is reported from the parking lot terminal, and when the parking time is received, the management server requests the payment settlement to the card system after adjusting the payment depending on the received parking time and rate.

Step (3130) may be subdivided into a step of receiving the parking time of the vehicle from the parking lot terminal and storing the parking time as parking information, a step of calculating the payment corresponding to the parking time, and a step of requesting the payment settlement through the electronic IC card to the card system. In particular, the step of calculating the payment depending on the parking time may further include a step of adjusting the payment by applying a discount rate which set differently for each parking time slot.

Hereinafter, the technical idea of the present invention will be described in more detail through a scenario depending on a signal flow between each component included in the automatic management system for an unmanned parking lot of the present invention.

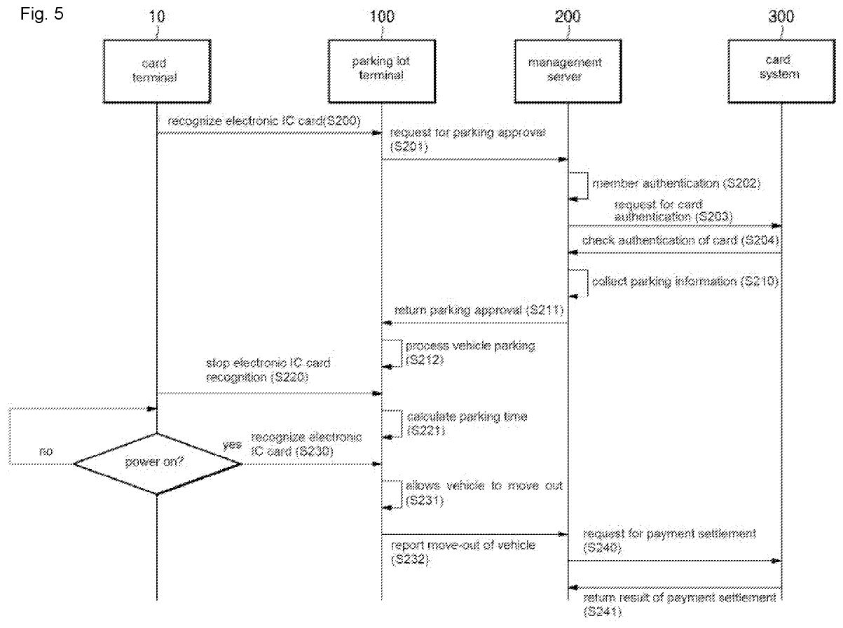

FIG. 5 is a sequence diagram illustrating a method for automatic management of an unmanned parking lot depending on an embodiment of the present invention.

Referring to FIG. 5, in the method of automatically managing an unmanned parking lot depending on an embodiment of the present invention, the parking lot terminal 100 recognizes the electronic IC card through the card terminal 10 mounted in the vehicle entering the parking surface, and receives information (S200). Accordingly, the parking lot terminal 100 transmits the card information to the connected management server 200 and requests the parking approval for the vehicle (S201).

Depending on step (3201), the management server 200 determines whether an identified vehicle owner has registered as a member by using the received card information, and if registered, authenticates the member registration (S202). In addition, the management server 200 requests the card system 300 to authenticate the electronic IC card depending on the card information through the information communication network (3203). The card system 300 determines whether the corresponding electronic IC card is normal, and if it is a normal card, the card system 300 checks the authentication of the electronic IC card (S204).

Accordingly, the management server 200 generates and collects parking information for the authenticated parking case and registers the parking of the vehicle (3210), and returns the parking approval depending on the request to the corresponding parking lot terminal 100 (S211).

Next, the parking lot terminal 100 processes the vehicle to park depending on the parking approval (S212). The parking lot terminal 100 may set a time point at which the ignition of the vehicle is stopped as a parking start time, and set a time point at which the vehicle is reignited as a parking termination time. Such a vehicle ignition state may be identified depending on the power on or off of the card terminal.

Accordingly, when the electronic IC card recognition is stopped after the parking process (S220), the parking lot terminal 100 determines that the vehicle ignition is stopped and sets the parking start time, and calculates the parking time during the parking period (S221).

Then, after a predetermined period of time has elapsed, when the power of the card terminal is turned on depending on the re-ignition of the vehicle; the parking lot terminal 100 recognizes the electronic IC card (S230), sets this time point as the parking termination time, and allows the corresponding vehicle to move out (S231). In addition, the parking lot terminal 100 reports the move-out of the vehicle from the parking surface to the management server 200 (S232).

Accordingly, the management server 200 terminates the task for the registered parking case and requests the card system 300 to pay for the parking case (S240). In addition, the card system 300 proceeds with the payment using the card information of the corresponding electronic IC card depending on the payment request and returns the result to the management server 200, thereby terminating the parking and settlement procedure for the parking case (S241).

Although many items are specifically described in the above description, this should be construed as an example of a preferred embodiment rather than limiting the scope of the invention. Accordingly, the invention should not be determined by the described embodiments, but should be defined by the claims and equivalents to the claims.

1. A system for automatically managing an unmanned parking lot, the system comprising:
a plurality of parking lot terminals installed in parking lots in each region and configured to communicate with a card terminal mounted in a vehicle approaching within a predetermined distance to recognize an electronic IC card and calculate a parking time; and
a management server configured to request authentication of the electronic IC card from a linked external card system, approve parking for an authenticated vehicle, and process a payment settlement procedure depending on the calculated parking time of the vehicle, in response to a request for parking approval and payment settlement from the plurality of parking lot terminals.

2. The system of claim 1, wherein the parking lot terminal includes:
a card recognition unit configured to recognize an adjacent electronic IC card through a wireless communication network;
a communication unit connected to the management server to perform data communication;
a time calculation unit configured to calculate the parking time of the vehicle;
a parking processing unit configured to perform a process of parking a currently recognized vehicle depending on parking approval by the management server; and
a control unit configured to request the parking approval and payment settlement to the management server and provide the calculated parking time to the management server when the parking is terminated.

3. The system of claim 2, wherein the time calculation unit is configured to set a time point at which recognition of the electronic IC card is terminated as a parking start time, and set a time point at which the electronic IC card is re-recognized as a parking termination time, after the parking is processed.

4. The system of claim 1, wherein the management server includes:
a terminal linking unit and a card linking unit connected to the plurality of parking lot terminals and a card system to perform data communication, respectively;
a parking management unit configured to request authentication of the electronic IC card to the card system depending on the parking approval request from the parking lot terminal, and return the parking approval to the parking lot terminal depending on an authentication result; and
a parking information collection unit configured to generate parking information for parking-approved cases, collect the generated parking information, and store the generated parking information in a parking information DB.

5. The system of claim 4, wherein the management server further includes a fee calculation unit configured to calculate a fee corresponding to the parking time and request payment settlement through the electronic IC card to a high-pass system.

6. The system of claim 5, wherein the management server further includes a rate setting unit configured to adjust the fee by applying a discount rate set differently for each time slot with reference to the parking information.

7. The system of one of claims 1 to 6, wherein the electronic IC card includes a high-pass card, a credit card, or a transportation card having a post-payment function.

8. A method of automatically managing an unmanned parking lot by a management server, the method comprising:
receiving, by the management server, a request for parking approval depending on recognition of an electronic IC card provided in a vehicle from a plurality of parking lot terminals installed in parking lots in each region;
receiving card information of the electronic IC card to determine whether the electronic IC represents a member, and requesting authentication of a vehicle from a linked card system in a case of a registered member;
performing a process of parking an authenticated vehicle and returning a parking approval to the parking lot terminal when the vehicle is authenticated by the card system; and
processing a payment settlement procedure depending on a calculated parking time of the vehicle when move-out of a vehicle is reported from the parking lot terminal as parking of the vehicle is terminated.

9. The method of claim 8, further comprising:
setting, by the parking lot terminal, a time point at which recognition of the electronic IC card is terminated as a start time point of the parking time between the returning of the parking approval and the terminating of the parking of the vehicle; and
setting, by the parking lot terminal, a time point at which the electronic IC card is re-recognized as a parking termination time.

10. The method of claim 9, wherein the processing of the payment settlement procedure includes:
receiving the parking time of the vehicle from the parking lot terminal and storing the parking time as parking information;
calculating a fee corresponding to the parking time; and
requesting payment settlement through the electronic IC card to the card system.

11. The method of claim 10, wherein the calculating of the fee corresponding to the parking time further includes:
adjusting the fee by applying a discount rate, which is set differently for each parking time slot.
